(19) United States
(12) Patent Application Publication
(10) Pub. No.: US 2008/0183492 A1
(43) Pub. Date: Jul. 31, 2008

(54) Method for Comparing Prescription Drug Formularies

(75) Inventors: Gregory L. Warren, Fox River Grove, IL (US); Janice Vaysberg, Vernon Hills, IL (US)

Correspondence Address: FRANCIS C. KOWALIK;WALGREEN CO. LAW DEPARTMENT, 104 WILMOT ROAD, M.S. #1425, DEERFIELD, IL, 60015, US

(73) Assignee: WALGREEN CO., Deerfield, IL (US)

(21) Appl. No.: 11/627,039

(22) Filed: Jan. 25, 2007

(51) Int. Cl. G06Q 50/00

(52) U.S. Cl. 705/2

(57) ABSTRACT

A method may enable a benefits consultant or other user to quantitatively compare competing PBM formularies across a representative sample of all drugs covered under a health benefits plan to present a comprehensive analysis of the formulary and its influence on a client's net cost. The method may determine a client's utilization data under the client's current formulary schedule. Also, it may determine a pharmacy benefits manager's (PBM) book of business utilization data under the PBM's formulary schedule. Further, the method may determine the utilization differences between the client's utilization data under the current formulary and the PBM's book of business utilization data under the PBM's formulary. Using the client and PBM utilization differences, the method may extrapolate a projected total cost for the client under the PBM's formulary.

### FIELD OF THE INVENTION

The present invention generally relates to benefit cost management methods and more particularly to a process for comparing the total costs associated with prescription drug pricing under different pharmacy benefits manager (PBM) formularies.

### BACKGROUND

Prescription drugs are distributed to patients through a number of different channels. Often, patients are members of an employee health benefits plan that allows them to receive drugs at reduced cost in exchange for paying a plan membership premium. From a member's perspective, the price of a prescription may be the costs associated with a plan membership plus a contracted deductible and co-payment amount for the drug. For other parties to the transaction, such as the benefit plan, manufacturer, and pharmacy, the drug price is determined by a highly-negotiated set of rules between several participants.

Pharmacy Benefits Managers (PBMs) are contracted by managers of a health benefits plan to administer the plan's prescription drug benefits. The PBMs act as intermediaries between health plans, on one side and, among others, the pharmaceutical companies and pharmacies on the other. A key responsibility of the PBM is to develop a pricing and reimbursement schedule for the health plan prescription drug program called a “formulary.” The formulary determines what drugs are covered under the health benefit program and/or how much the member will pay for covered prescriptions.

In a common purchasing relationship, pharmacies purchase drugs from drug companies or wholesalers and dispense the drugs through prescriptions to health plan members. Health benefits plans, in turn, may directly reimburse the pharmacy for the total amount for the drug (the “ingredient cost” plus the “dispensing fee” minus the member co-payment given to the pharmacy), or pay the PBM an amount over the ingredient cost and dispensing fee. The PBM may then retain the difference as a profit. PBMs negotiate with pharmaceutical companies and pharmacies to get the best pricing terms for the benefits plan and member, but may also evaluate the effectiveness of drugs to create formularies of the most cost-effective drugs for treating any number of conditions or diseases.

In general, the formulary can affect the profit of nearly all entities involved in the prescription drug transaction to include the manufacturers, pharmacies, health benefits plan, and the PBM. When considering a PBM for the health plan, benefits consultants working for the plans evaluate competing PBM formularies. For the benefits consultants and, in turn, the health plan managers, an ideal formulary provides the most effective prescription coverage to plan members, but also delivers the lowest net cost across all drugs offered by the plan (the plan's “drug spend”). Because determining the lowest net cost formulary is an inherently quantitative assessment, an objective analysis of each PBM's formulary across the plan's drug spend may be a valuable component of this assessment. However, due to the complexities of objectively accounting for the pricing influence of a meaningful number of products across an entire drug spend, benefits consultants often financially evaluate a PBM based merely on negotiated incentives offered by the PBM to the health plan in the form of “rebates” and “discounts” in addition to the fees charged to the health plan by the PBM.

The rebate incentives are offered by drug manufacturers to influence the PBM's decision to include specific drugs on the formulary and thereby realize sales profit. Drugs placed on the formulary are “preferred” over other “non-preferred” and often collect a higher incentive return. Therefore, the PBM's profit may be determined by a combination of service fees for administering the plan's prescription program and, perhaps more importantly, by sharing a portion of the incentives given by the drug manufacturer. To increase profits, a PBM may be motivated to include a drug on the formulary that increases an incentive amount despite also increasing the plan's net cost to the benefits plan for prescriptions across the drug spend.

Each drug included on the formulary may be sold or reimbursed at some discounted rate from an Average Wholesale Price (AWP). The AWP is a figure reported by commercial publishers of drug pricing data, such as First DataBank. The AWP pricing information is based on data obtained from manufacturers, distributors, and other suppliers. This pricing information is then sold to pharmacies and other purchasers of prescription drugs. The AWP is comparable to an automobile “sticker price” in that the manufacturer suggests a price, but almost all buyers pay something different. There is currently no requirement that the AWP reflect the price of any actual sale of drugs by a manufacturer, or that it be regularly updated. It is not defined by law, and it may not capture actual transaction costs and profits including the discounts and rebates from the manufacturer to various payers.

For example, most health plans reimburse a pharmacy through the PBM according to the AWP, but also extract a discount from the pharmacies to arrive at an ingredient cost for the drug. Further, pharmacies may purchase the drugs from wholesalers or manufacturers at some percentage discount from the AWP and retain the difference between their actual reimbursement (the purchase price minus a co-payment amount, plus any dispensing fees) and their actual cost as profit. A PBM's formulary may dictate that the health plan only reimburses 85% of the AWP of drug X minus the member's co-payment and plus any dispensing fees. The pharmacy may then be reimbursed by a particular health benefits plan at 85% of the AWP, minus a $25 co-payment and plus a $2 dispensing fee. If the AWP was $100, the plan would reimburse the pharmacy $85, minus the $25 co-payment and plus the $2 dispensing fee for a total reimbursement of $63. Here, the pharmacy would likely need to be able to purchase the product for at least AWP minus 15% in order to realize a profit. The pharmacy may then bill the plan through the PBM for the reimbursement amount of $63. However, the PBM may add an additional administrative fee to arrive at a net cost to the health plan.

Rebates may provide another incentive to the PBM to include manufacturers' products on the formulary, or for benefits plans to choose PBMs based on the inclusion of high-rebate drugs on a formulary. Generally, rebates constitute a manufacturer's rebate calculated as a percentage of the AWP that flows through the PBM to the PBM's benefits plan clients. The PBM may extract a portion of the rebate. The rebate is based on the market share that a manufacturer expects to see for its product within a PBM's total book of business. The rebate disbursement from the PBM to the clients will be based on the actual utilization pattern of the drug for each client within the PBM's book of business, that is, the difference in the number of lower cost drug types and classifications utilized by the client over higher cost drugs.

For example, a manufacturer and PBM may agree that sales of drug X for one year at AWP will be $5 million. The manufacturer may then agree to “rebate” back to the PBM 10% of the AWP for all units of drug X dispensed though the PBM's formulary. Continuing with the previous example, if drug X's AWP was $100, a $10 rebate may flow through the PBM to the benefits plan clients for each sale. The PBM would ultimately receive $500,000 from the manufacturer to pass to the client. The PBM, acting on behalf of its client's health plans, could receive some of the $500,000 as a fee for services. The PBM would remit the remainder back to the plans and, therefore, the total rebate to each client will be based on the client's utilization pattern for the drug.

In combination with the incentives, the costs to the health plan for prescription drugs may be summarized as:

Average Wholesale Price−Pharmacy Discount=Ingredient Cost

Ingredient Cost+Pharmacy Dispensing Fee=Total Cost

Total Cost−Health Plan Member's Co-Payment=Point of Sale Plan Cost

Point of Sale Plan Cost+PBM Administrative Fees=Net Cost

Net Cost−Rebates Returned to Health Plan=Final Net Cost

Therefore, all health plans should desire a formulary that will result in the lowest Final Net Cost. However, the health plans' interest to reduce costs must be balanced against the PBM's desire to increase profits. For example, any increase in the published AWP can significantly increase revenue for the manufacturer. Because PBM profits may be based on a percentage discount or rebate of the AWP, a higher AWP may result in increased profits. Further, because the AWP is a published cost used as an approximate, industry-wide price basis, any fluctuation in AWP would affect all PBMs roughly equally. Also, because the PBM's stated discount and rebate amount have the most highly visible and easily quantifiable influence on the final net cost, benefits consultants generally only consider these incentives when determining a low net cost formulary strategy. Therefore, a PBM may be motivated to negotiate an increased rebate or discount amount to increase profits and present a formulary with an apparent low net cost strategy.

Currently, because of the complexities of accounting for the influence of both the AWP and pricing incentives across an entire drug spend, objective assessment of each PBM's formulary may be impossible. During the evaluation and negotiation process, a benefits consultant may ask several subjective questions regarding the PBM's ability to provide services to plan members in a Request for Proposal (RFP). Objective questioning in the RFPs may only consider the impact of incentives on the net cost. However, supported by merely subjective determinations and incentive comparison, all PBMs may make similar claims of providing an effective low net cost formulary for their clients.

Without a more comprehensive analysis, a PBM may present higher rebates than a competing PBM's formulary, yet the final net cost to the client of the larger-incentive formulary may be higher than another formulary with lower incentives. Therefore, using subjective and objective factors that are limited to incentive comparison when evaluating formularies may not adequately account for all essential factors to effectively evaluate a PBM's low net cost strategy formulary.

### SUMMARY OF THE INVENTION

Because the greatest impact on the clients's final net cost is likely the different utilization patterns as influenced by the PBM's formulary, the lowest net cost formulary strategy may be determined by comparing competing PBM formularies to account for the influence of all transaction costs and the drug utilization patterns influenced by the formulary. A comprehensive objective analysis of competing formularies may require determining the influence of numerous pricing schemes for hundreds of different products across the client's drug spend to account for rebate and discount incentives as well as reimbursement rates and the drug utilization patterns that result. A method may enable a benefits consultant or other user to quantitatively compare competing PBM formularies across a representative sample of all drugs covered Linder a health benefits plan to present a comprehensive analysis of the formulary and its influence on a client's net cost. The method may determine a client's utilization data under the client's current formulary pricing schedule. The client's utilization data may include data for the client's entire drug spend to include a total number of prescriptions filled per drug. Also, it may determine a PBM's book of business utilization data under the PBM's formulary pricing schedule. The PBM's utilization data may include data for drugs within a subset of their clients' drug spend to include the total number of prescriptions filled per drug that the PBM receives from its clients and the total number of prescriptions filled under the PBM's formulary. Further, the method may determine the utilization differences between the client's utilization data under the current formulary and the PBM's book of business utilization data under the PBM's formulary. In addition, the method may extrapolate a projected total cost for the client under the PBM's formulary from the client and PBM utilization differences.

### BRIEF DESCRIPTION OF THE DRAWINGS

FIGS. 1 and 2 are block diagrams of a computing system that may operate in accordance with the described embodiments;

FIG. 3 is a prior art method of comparing a client's total cost under several PBM formulary pricing schedules;

FIG. 4 is a flowchart illustrating an exemplary method for comparing prescription drug formularies; and

FIGS. 5 through 12 are exemplary spreadsheet sections used in comparing prescription drug formularies.

### DETAILED DESCRIPTION

Although the following text sets forth a detailed description of numerous different embodiments, it should be understood that the legal scope of the invention is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

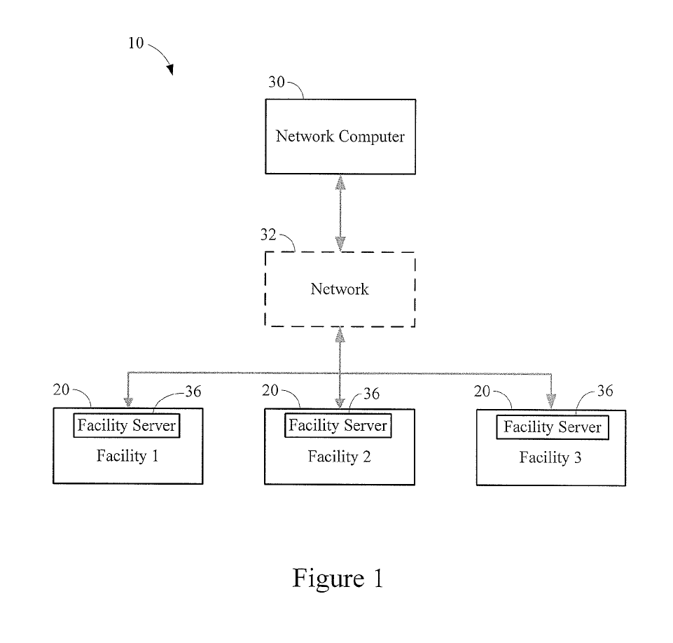

FIG. 1 illustrates an embodiment of a data network 10 including a first group of pharmacies 20 operatively coupled to a network computer 30 via a network 32. The plurality of pharmacies 20 may be located, by way of example rather than limitation, in separate geographic locations from each other, in different areas of the same city, or in different states. The network 32 may be provided using a wide variety of techniques well known to those skilled in the art for the transfer of electronic data. For example, the network 32 may comprise dedicated access lines, plain ordinary telephone lines, satellite links, combinations of these, etc. Additionally, the network 32 may include a plurality of network computers or server computers (not shown), each of which may be operatively interconnected in a known manner. Where the network 32 comprises the Internet, data communication may take place over the network 32 via an Internet communication protocol.

The network computer 30 may be a server computer of the type commonly employed in networking solutions. The network computer 30 may be used to accumulate, analyze, and download pharmacy data. For example, the network computer 30 may periodically receive data from each of the pharmacies 20 indicative of information pertaining to a prescription order, billing information, employee data, etc. The pharmacies 20 may include one or more facility servers 36 that may be utilized to store information for a plurality of customers/employees/accounts/etc. associated with each facility.

Although the data network 10 is shown to include one network computer 30 and three pharmacies 20, it should be understood that different numbers of computers and pharmacies may be utilized. For example, the network 32 may include a plurality of network computers 30 and dozens of pharmacies 20, all of which may be interconnected via the network 32. According to the disclosed example, this configuration may provide several advantages, such as, for example, enabling near real time uploads and downloads of information as well as periodic uploads and downloads of information. This provides for a primary backup of all the information generated in the process of updating and accumulating pharmacy data.

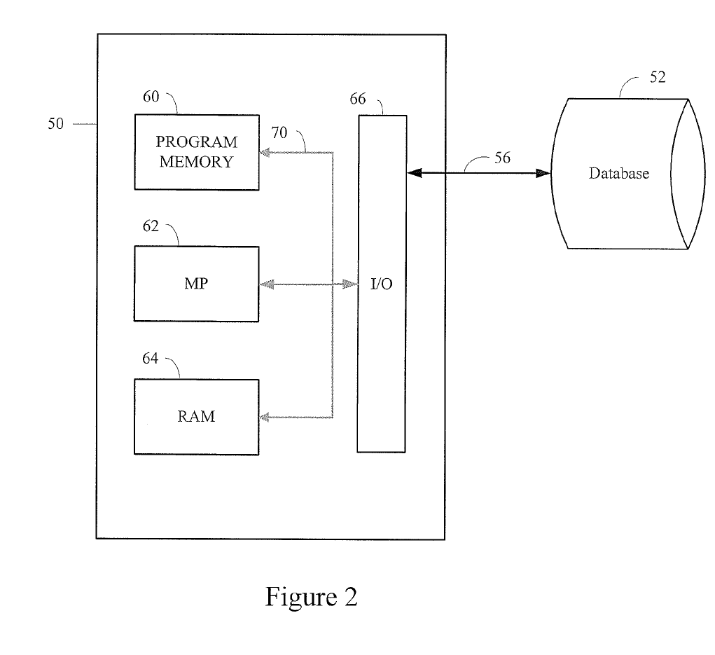

FIG. 2 is a schematic diagram of one possible embodiment of the network computer 30 shown in FIG. 1. The network computer 30 may have a controller 50 that is operatively connected to a database 52 via a link 56. It should be noted that, while not shown, additional databases may be linked to the controller 50 in a known manner.

The controller 50 may include a program memory 60, a microcontroller or a microprocessor (MP) 62, a random-access memory (RAM) 64, and an input/output (I/O) circuit 66, all of which may be interconnected via an address/data bus 70. It should be appreciated that although only one microprocessor 62 is shown, the controller 50 may include multiple microprocessors 62. Similarly, the memory of the controller 50 may include multiple RAMs 64 and multiple program memories 60. Although the I/O circuit 66 is shown as a single block, it should be appreciated that the I/O circuit 66 may include a number of different types of I/O circuits. The RAM(s) 64 and programs memories 60 may be implemented as semiconductor memories, magnetically readable memories, and/or optically readable memories, for example.

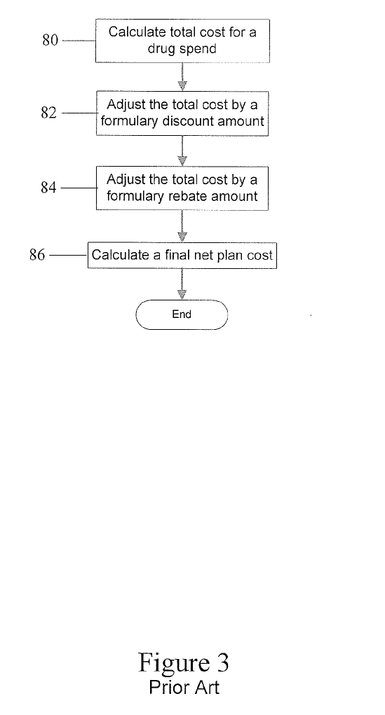

FIG. 3 is a flowchart illustrating a prior art method for evaluating a PBM's formulary that may be executed on a computing system as illustrated in FIGS. 1 and 2. The benefits consultant may have used a limited comparison of PBM formulary incentives to evaluate competing drug pricing schedules. For example, in block 80, a benefits consultant may have calculated the total cost for all prescription drugs under a current PBM formulary. At block 82, the benefits consultant may then have adjusted the total cost by a new PBM's discount amount. The discount amount may have been an amount discounted from the Average Wholesale Price (AWP) for each drug. Additionally, the discount may have been a different amount for each drug depending on the drug's classification as a generic or brand drug. At block 84, the benefits consultant may also adjust the calculated total cost by a rebate amount, as previously described. After accounting for both incentive reductions to the total cost, at block 86, the benefits consultant may determine a final net plan cost.

However, the prior art calculations cannot account for the different outcomes in overall pricing and incentive returns for generic, preferred brand, and non-preferred brand classifications that result from different utilization patterns for each drug within competing formularies. For example, while the benefits consultant may negotiate with the PBM for a discount from the AWP and a rebate per prescription filled, incentives are applied differently depending upon the drug's classification. Likewise, the co-payment amounts that members may pay to benefits plans through the pharmacies may be different depending on the drug classification. Because prior art methods could not account for the variations in total cost under different formularies due to incentives, member co-payments, and different utilization patterns, past calculated total costs may have been inaccurate and incomplete.

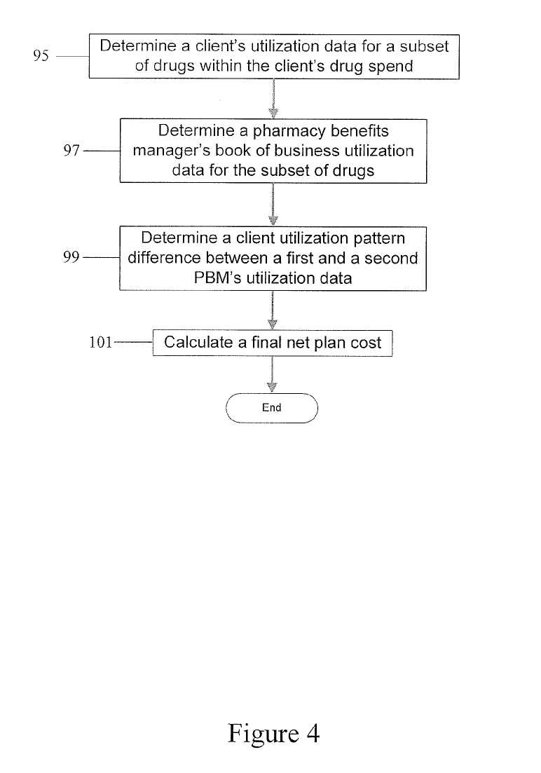

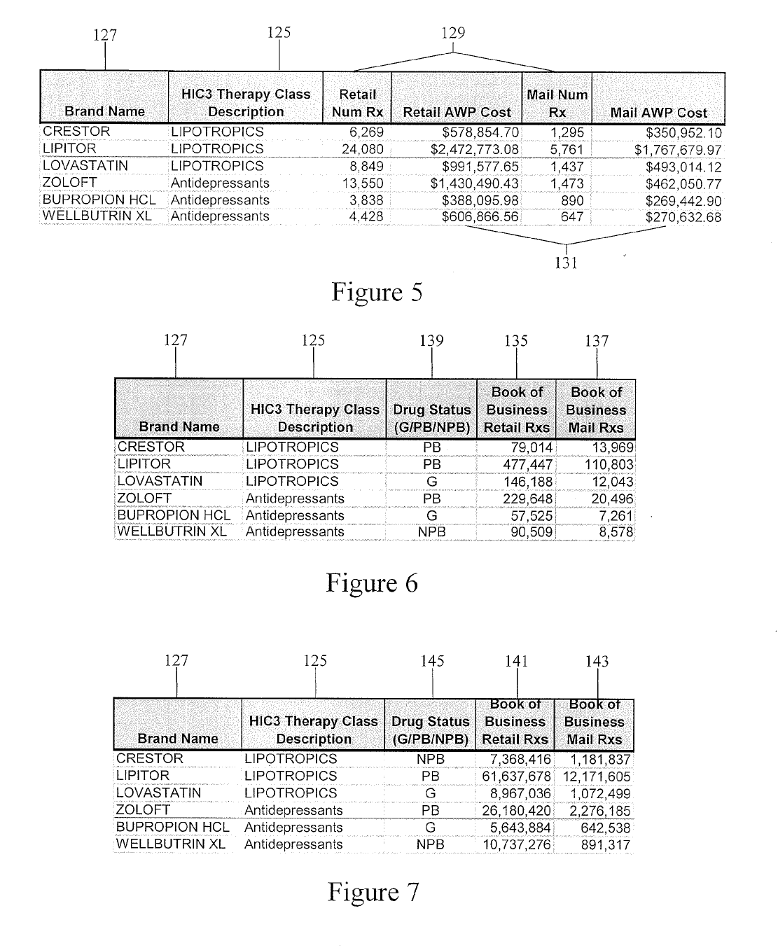

With reference to FIG. 4 and FIG. 5, a flowchart may illustrate an example of a method that may accurately account for both incentives and co-payment amounts across different PBM formularies having different combinations of generic, preferred brand, and non-preferred brand classifications within the same subset of drugs. For all following examples, any apparent discrepancies in the numerical results may be accounted for by rounding adjustments. A benefits consultant may implement the method using a spreadsheet program such as Excel % manufactured by the Microsoft Corporation of Redmond, Wash. Further, the following steps may be performed as a routine programmed to execute on the computing system of FIGS. 1 and 2, with the data elements referred to herein gathered from a local or remote data repository or inputted manually or individually at any point during execution of the routine. For example, the following steps may be executed as part of the relational aspects of a spreadsheet system or program, or may also be executed by the microprocessor 62 from a program code stored in one or more of the storage devices 52, 60, 64. The operations may also be controlled and performed using other control logic, either analog or digital, and may be performed in any order.

At block 95, the method may determine a client's utilization data for a subset of drugs within the drug spend PBM clients may include employer groups, managed care organizations, and any other entity requiring a PBM to administer a prescription drug program. The subset of drugs may be chosen from all drugs administered to the client's members, as classified into a number of drug function categories, or HIC3 Therapy Class Descriptions 125 as recorded by First Databank. For example, the drugs 127 Crestor®, Lipotor®, and Lovastatin may be grouped by their therapy class 125 as “Lipotropics” while the drugs 127 Zoloft®, Bupropion SR, and Wellbutrin XL® may be grouped by therapy class 125 as “Antidepressants.”

To reduce the number of calculations, the subset of drugs may be those that have the greatest effect on formulary comparisons. For example, the subset may include those drugs with formulary statuses, such as preferred or non-preferred, that may have the most significant effect on the total cost to the client. Similarly, the subset of drugs may include those that, between other formularies, have the highest variance in AWP. The utilization data may include, for all retail and mail-order prescriptions, the total number of prescriptions filled 129 for all of the client's members for each drug within the subset and the total AWP 131 for each drug (not accounting for any incentive reductions). The client utilization data may be obtained from the client or the client's PBM by completing a Data Request as part of the benefits consultants' evaluation of the PBMs.

At block 97, and with reference to FIG. 6, the utilization data for a PBM may be obtained. As with the client's utilization data in block 95, the PBM utilization data may be for an identical subset of drugs. However, the data retrieved may be for the combination of all the PBM's clients that are within the same class of clients as the client from which the utilization data was obtained in step 95. By obtaining PBM data for a similar class of clients, comparisons between PBM formulary pricing schedules may more accurately reflect a total cost to the client should the client receive services from each evaluated PBM. The PBM utilization data may include the retail 135 and mail 137 number of prescriptions filled for each drug 127 across the PBM's entire book of business for similar clients. The book of business may be all employer groups, all managed health care programs, or other sets of clients with similar needs and backgrounds of the client described at block 95 that the PBM serves.

Along with the number of retail 135 and mail 137 book of business prescriptions, the status 139 of each drug 127 within the subset may be obtained. The PBM may assign a status of generic (G), preferred brand (PB), or non-preferred brand (NPB) to each drug 127 within the subset. The PBM may assign the drug status as part of negotiations with drug manufacturers. As previously described, including a drug on a formulary as “preferred” may increase PBM profits by increasing incentives paid for each preferred prescription filled. A PBM may assign a drug to the formulary based on its effectiveness and the cost of the drug for the PBM's clients. Further, the cost of the drug may be affected by rebates offered by the manufacturer, which may, in turn, stipulate conditions on the drug's inclusion on the formulary, such as that the drug must be within a particular pricing classification or that only a limited number of competitors of the drug may be included on the formulary.

To compare other formularies, utilization data may be obtained from other PBMs in a similar fashion. With reference to FIG. 7, the utilization data may include other PBMs' retail 141 and mail 143 book of business prescriptions for comparable clients. The PBM may assign a different drug pricing classification 145 to a drug within the subset, for example, the classification of “Preferred Brand” as compared to “Non-Preferred Brand” for Crestor® between the PBMs represented in FIGS. 6 and 7, respectively. The differences in drug classification may result in different total costs for the client under each formulary. Like the client utilization data, the PBM utilization data may be obtained from a PBM by a benefits consultant in an RFP as part of evaluating competing PBM proposals.

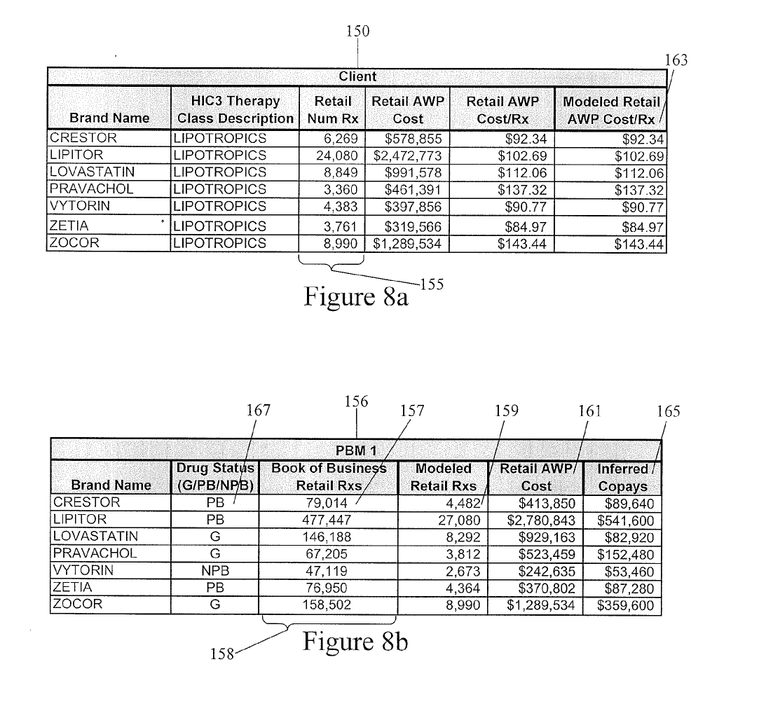

At block 99, a client utilization pattern difference between different PBMs' utilization data may be determined. For example, the number of prescriptions filled and the price paid for the prescriptions may be projected from one formulary to another based on the relative differences between the PBM's book of business utilization data. One method of projecting the client's utilization data to another PBM's formulary may be to infer the number of prescriptions the client might fill from the current number of prescriptions for the entire Therapy Class Description 125. The number of retail prescriptions for a particular drug may be modeled or inferred as the client's total number of prescriptions for all drugs in the same Therapy Class Description 125 as the particular drug, multiplied by the PBM's book of business number of prescriptions for the drug, divided by the PBM's book of business number of prescriptions for all drugs in the same Therapy Class Description 125. For example, as shown in FIG. 8a, the current client 150 may have a total of 59,692 prescriptions filled in the Therapy Class Description of “Lipotropics” 155. The client's total therapy class prescriptions (59,692) multiplied by the PBM's book of business number of prescriptions for Crestor® (79,014) 157 and divided by the PBM's total book of business number of prescriptions for the Therapy Class (1,052,425) 158 may equal a modeled number of prescriptions 159 for the PBM (4,482). This modeled number of prescriptions 159 may describe the number of prescriptions the client may expect or infer if the client were to use the PBM's 156 formulary.

From the inferred number of prescriptions 159, the total retail cost at AWP of the inferred number of prescriptions 161 may be calculated from a modeled AWP cost per prescription 163. The modeled AWP cost per prescription may be a prediction of the cost per prescription the PBM will likely get for the client if the client's utilization matched the PBM's book of business utilization. Additionally, the amount the client may receive from member co-payments 165 may be inferred by the modeled number of prescriptions for the drug 159 multiplied by an amount of a co-payment for the drug status 167. For example, Crestor®, as a drug with a “Preferred Brand” drug status 167, may have a co-payment amount of $20 resulting in a total amount of inferred member co-payments 165 from Crestor®(with a modeled number of 4,482 prescriptions) of $89,640. The same calculations may be performed for all selected retail and mail order prescriptions within the same subset of drugs.

At block 101, the total cost to a client for a prescription benefits plan under a PBM's formulary pricing schedule may be determined by accounting for differences discovered between the several formularies at block 99. The total cost may account for the utilization difference in prescription drug cost, to include discount incentives, as well as the differences in member contribution through co-payments. The total cost may be determined through a series of calculations that project the client's current utilization data for the subset of drugs under a first formulary to a second formulary while accounting for differences between the first and second formularies including, but not limited to, drug classifications, manufacturers' incentives, member co-payment contributions, and drug utilization patterns. The calculations may be segregated by any number of drug classifications to include brand (including different brand sub-classifications and categories such as preferred brand, non-preferred brand, single-source brand (SSB), multiple-source brand (MSB), and MSB with generic available) and generic. Also, the calculations may be segregated between retail and mail order transactions. The calculations may determine a series of projected adjustments to the total cost determined under an evaluated PBM's formulary and, thereby, extrapolate an inferred total cost for the client under various different PBM formularies.

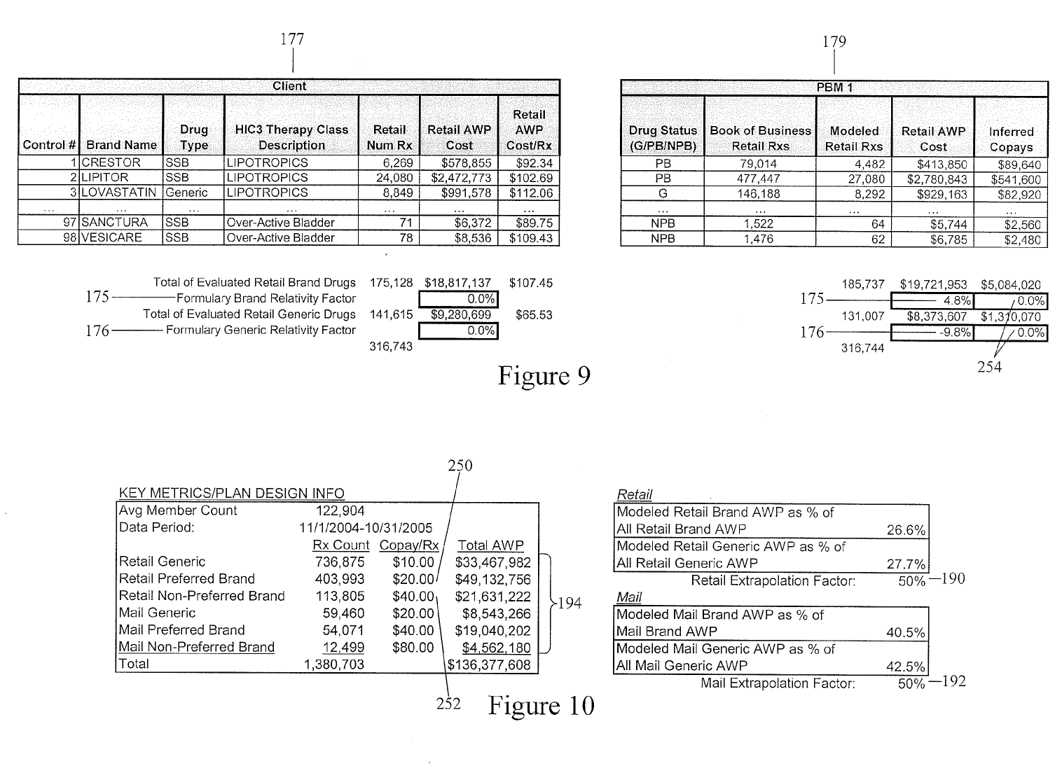

One calculation may be an adjustment to the ingredient cost. An ingredient cost adjustment may account for the difference in the total retail and mail order AWP costs for all prescriptions filled based on the comparison patterns between PBMs that are evident in their book of business data as determined in block 99. For example, with reference to FIG. 9, a Relativity Factor 175, 176 for both the generic 175 and branded drugs 176 may be determined. The relativity factor 175, 176 may be a representation of the average difference in AWP between the client 177 and the evaluated PBM 179 for the subset of drugs. As previously stated, the subset of drugs may be those drugs, common to both the client's current formulary and the evaluated PBMs formulary that have the greatest influence, by therapeutic classification, on the total cost to the client. The relativity factor 175, 176 may then be applied to the subset of drugs. For example, for the PBM 179, the relativity factor 175 of 4.8% may be applied to the subset of drugs.

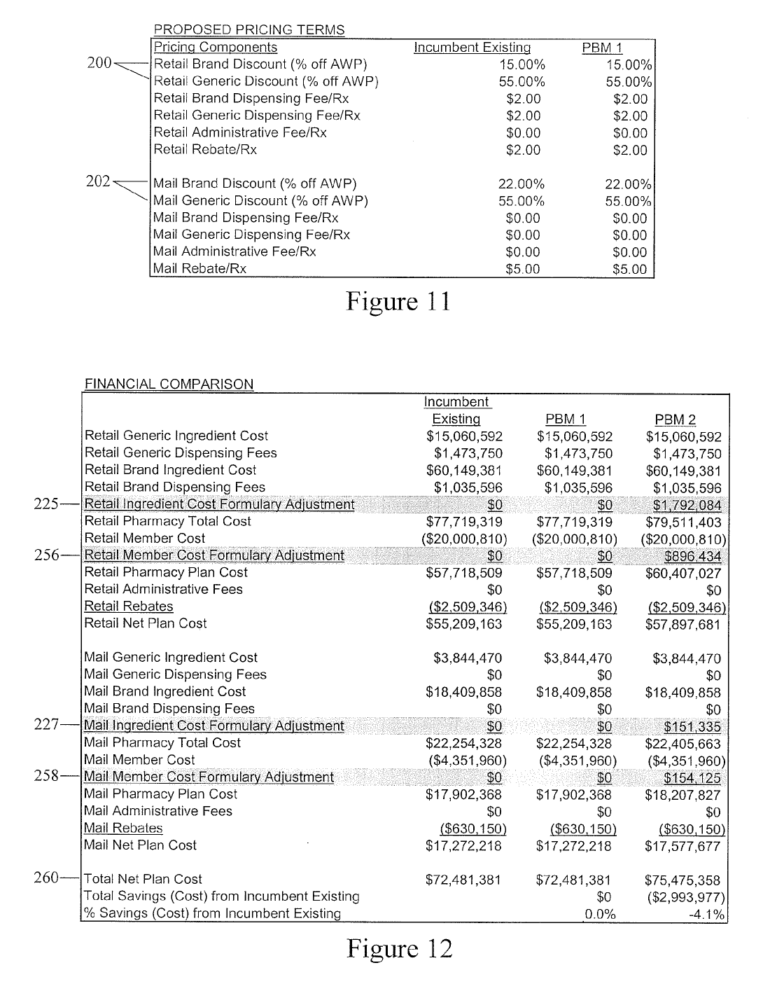

The AWP for the remaining drugs in the drug spend may be extrapolated by applying a percentage of the relativity factor 175, 176. As illustrated in FIG. 10, the percentage may be an Extrapolation Factor 190, 192 that may be applied to the AWP of the remaining drugs in the client's drug spend. Continuing with the previous example, using an extrapolation factor 190 of 50%, the relativity factor 175 of 4.8% may be applied to the remaining drug spend (calculated from client's total AWP 194) as 2.4%. Allowing a user to select an extrapolation factor 190, 192 may account for any discrepancies the user feels occurred in selecting the subset of drugs. Therefore, the relative differences in AWP between the client's total cost and a projected total cost under an evaluated PBM's formulary may be extrapolated to the client's entire drug spend to a variable degree, as selected by the user. With reference to FIGS. 11 and 12, the discount incentive 200, 202 may also be applied and subtracted from the AWP to arrive at a final retail and mail-order Ingredient Cost Formulary Adjustment 225, 227.

Another calculation may be an adjustment to the member cost. A member cost adjustment may account for differences in member co-payment amounts due to different drug classifications between the client's current formulary and an evaluated PBM's formulary. As previously explained, a member may pay a different co-payment amount for a prescription depending on the PBM's classification of the drug as preferred brand, non-preferred brand, and generic. As illustrated in FIGS. 6 and 7, two PBMs may classify the same drug differently 139, 145. As illustrated in FIG. 10, the co-payment amount for a preferred-brand drug 250 may be different than the amount for a non-preferred brand drug 252. Once the utilization mix is applied as described in block 99, member co-payment amounts for retail and mail prescriptions may be calculated within the different drug classifications of the evaluated PBM's formulary. As with the Ingredient Cost Formulary Adjustment 225, 227, the percentage difference between the client and the evaluated PBM 254 (FIG. 9) may be projected to all drugs within the subset and extrapolated, as determined by the user, to all other drugs within the client's drug spend to arrive at a final retail and mail-order Member Cost Formulary Adjustment (FIG. 12) 256, 258.

As further illustrated in FIG. 12, other, more accessible factors may be applied to the total cost to arrive at a final net cost 260. The final net cost 260 may then be used to compare the client's data against other PBMs' data to complete a quantitative assessment of several formularies. The user may, therefore, quantitatively determine a lowest net cost formulary pricing schedule without merely relying on incentive comparisons or other less accurate measures.

What is claimed:

1. A method of quantitatively evaluating formulary schedules comprising:
determining a client's utilization data for at least a portion of a client's drug spend, the client utilization data including a total number of prescriptions filled per drug under a first formulary schedule;
determining a pharmacy benefits manager's book of business utilization data for a plurality of drugs from the client's drug spend, the book of business utilization data including the total number of prescriptions filled per drug that the pharmacy benefits manager receives from a plurality of clients, the total number of prescriptions filled according to a second formulary schedule;
determining a client utilization difference pattern between the client's utilization data and the pharmacy benefits manager's book of business utilization data for the plurality of drugs from the client's drug spend; and
determining, from the client utilization difference pattern, a projected total cost for the client under the second formulary schedule;
wherein, between the first and second formulary schedule, the client utilization difference pattern includes a drug cost difference and a member cost difference for the plurality of drugs.

2. The method of claim 1, wherein a drug spend includes all drugs the client has ordered during a period of time.

3. The method of claim 1, wherein the client's utilization data includes a number of prescriptions for the plurality of drugs and a total cost to the client for the prescriptions.

4. The method of claim 1, wherein the client's utilization data and the pharmacy benefits manager's book of business utilization data includes a drug formulary status for each of the plurality of drugs, the drug formulary status being one of generic, preferred brand, or non-preferred brand.

5. The method of claim 4, wherein the drug formulary status includes at least one of a rebate, a discount, or a co-payment.

6. The method of claim 5, wherein the drug cost difference includes the discount.

7. The method of claim 5, wherein the member cost difference includes the co-payment.

8. The method of claim 1, wherein determining, from the client utilization difference pattern, the projected total cost for the client under the second formulary schedule comprises extrapolating the projected total cost for the client under the pharmacy benefits manager's formulary from the client utilization difference pattern.

9. The method of claim 1, wherein each of the plurality of clients is substantially similar to the client, both the plurality of clients and the client being members of a client class, the client class including at least one of a managed health care plan or a group of employers.

10. A method for quantitatively evaluating formulary schedules comprising:
determining a client's utilization data for a client's drug spend including all drugs the client has ordered during a period of time, the client utilization data including a total number of prescriptions filled per drug under a first formulary schedule, a total number of prescriptions filled for a subset of the total number of prescriptions filled per drug under the first formulary schedule, and a total cost to the client for each of the total number of prescriptions filled per drug and the subset;
determining a pharmacy benefits manager's book of business utilization data for the subset, the book of business utilization data including the total number of prescriptions filled per drug that the pharmacy benefits manager receives from a plurality of clients within the same client class as the client, the total number of prescriptions filled according to a second formulary schedule;
determining a client utilization difference pattern between the client's utilization data and the pharmacy benefits manager's book of business utilization data for the subset; and
determining, from the client utilization difference pattern, a projected total cost for the client under the second formulary schedule;
wherein, between the first and second formulary schedule, the client utilization difference pattern includes a drug cost difference and a member cost difference for the subset.

11. The method of claim 10, wherein the client's utilization data and the pharmacy benefits manager's book of business utilization data includes a drug formulary status for each drug of the subset, the drug formulary status being one of generic, preferred brand, or non-preferred brand.

12. The method of claim 10, wherein the drug formulary status includes at least one of a rebate, a discount, and a co-payment;
wherein the drug cost difference includes at least one of the discount and the rebate; and
wherein the member cost difference includes the co-payment.

13. The method of claim 10, wherein the projected total cost for the client under the second formulary schedule comprises the projected total cost for the client under the pharmacy benefits manager's formulary from the client utilization difference pattern.

14. The method of claim 10, wherein the same client class as the client includes at least one of a managed health care plan or a group of employers.

15. A method of quantitatively comparing a first formulary schedule and a second formulary schedule, the first and second formulary schedules having a plurality of drugs, the plurality of drugs including a unique distribution of generic, preferred brand, and non-preferred brand drugs, the drugs being common to both of the first and second formulary schedules, the method comprising:
determining first utilization data of the first formulary schedule and second utilization data of the second formulary schedule;
determining a utilization pattern between the first and second utilization data;
extrapolating the first utilization data to the second formulary schedule by the utilization pattern;
calculating a total cost for the plurality of drugs under each of the first formulary schedule and the second formulary schedule, the total cost for the second formulary schedule including the utilization pattern;
adjusting the total cost for the second formulary schedule by each of a relativity factor, an incentive amount, and a member co-payment amount;
wherein the relativity factor describes a difference between the total cost for the plurality of drugs under the first formulary schedule and the total cost for the plurality of drugs under the second formulary schedule;
calculating a final net plan cost for each of the first formulary schedule and the second formulary schedule; and
determining a lowest net cost formulary by comparing the final net plan cost of the first formulary schedule to the final net plan cost of the second formulary schedule.

16. The method of claim 15, wherein each of the plurality of drugs is one of generic, preferred brand, or non-preferred brand.

17. The method of claim 15, wherein the plurality of drugs includes a plurality of therapeutic classes, each of the therapeutic classes including a plurality of functionally similar drugs.

18. The method of claim 15, wherein the incentive amount includes a discount amount for each of the plurality of drugs, the discount amount including one of a generic discount or a brand discount.

19. The method of claim 15, wherein the incentive amount includes a rebate amount for each of the plurality of drugs, the rebate amount including one of a retail rebate or a mailrebate.

20. The method of claim 15, wherein the member co-payment amount includes, for each of the plurality of drugs, one of a generic co-payment, a preferred brand co-payment, or a non-preferred brand co-payment.
